(19) United States
(12) Patent Application Publication
(10) Pub. No.: US 2021/0238800 A1
(43) Pub. Date: Aug. 5, 2021

(54) METHOD FOR PREPARING CHITOSAN AND DERIVATIVE NANOFIBER THEREOF BY MECHANICAL MEANS

(71) Applicant: SOUTH CHINA UNIVERSITY OF TECHNOLOGY, Guangzhou (CN)

(72) Inventors: Guanglei ZHAO, Guangdong (CN); Sihan ZHANG, Guangdong (CN); Xiaofeng LI, Guangdong (CN)

(73) Assignee: SOUTH CHINA UNIVERSITY OF TECHNOLOGY, Guangdong (CN)

(21) Appl. No.: 17/049,970

(22) PCT Filed: Oct. 31, 2018
(86) PCT No.: PCT/CN2018/113231

§ 371 Date: Oct. 23, 2020

(30) Foreign Application Priority Data
May 31, 2018 (CN) 201810551929.1

(51) Int. Cl. D21B 1/34; D21H 13/30; D21B 1/02

(52) U.S. Cl. CPC D21B 1/34; D01F 9/00; D21B 1/021; D21H 13/30

(57) ABSTRACT

The invention discloses a method for preparing chitosan and a derivative nanofiber thereof by mechanical means. The method comprises: firstly pre-treating a chitosan fiber or a chitosan derivative fiber material (referred to as chitosan fiber) of a suitable length with water or alkali or acid of an appropriate concentration added, then refining or beating the treated fiber (preferably using a beating device in a beating and papermaking process) to obtain a micro-sized chitosan fiber, and finally homogenizing the micro-sized chitosan fiber under a high pressure to obtain a chitosan nanofiber. According to an electron microscope image, the obtained chitosan nanofiber reaches a nano-level. The method is simple in operation and convenient for industrial production, and the obtained chitosan nanofiber with a new topology has broad application prospects in biomedicine, daily chemical engineering and special materials.

### BACKGROUND

### Technical Field

The present invention relates to the field of nano materials like daily chemicals and biomedicine, and more particularly, relates to a method for preparing chitosan and a derivative nanofiber thereof by mechanical means.

### Description of Related Art

Chitosan, also known as soluble chitin, carapace amine, chitosan, etc., with a chemical name of 2-amino-β-1,4-glucan, is a natural cationic polysaccharide obtained after deacetylation of chitin. The chitosan and derivatives thereof have excellent properties such as a good biocompatibility, a degradability, a hygroscopicity, a non-toxicity, an antibacterial property, a fiber-forming property, a film-forming property, and certain antibacterial and anti-tumor properties, and have broad application prospects in medicine, food, textile, daily chemicals, environmental protection and other fields. The chitosan is widely distributed in nature, with a laudatory title of universal polysaccharide, and is a cheap and easily available raw material. At present, for chitosan nano materials, emulsion liquid dripping, an emulsion solvent diffusion method, a reverse micelle method and a polyelectrolyte complexation method are mainly used to prepare chitosan nanoparticles, and a freeze-drying method is also used to prepare a chitosan nanofiber. The chitosan nanoparticles are widely used in biomedicine and metal particle composite materials. However, due to a limitation of a preparation method, a preparation form of the chitosan nanoparticles may only be a spherical-like particle, and other forms cannot be prepared. Moreover, the nano chitosan in a fiber form also has excellent properties, such as a relatively large specific surface area, a high strength, a high crystallinity and an ultra-fine structure. Although the freeze-drying method may be used to prepare the chitosan nanofiber, a manufacturing cost thereof is high, and liquid nitrogen needs to be used during treatment, so that the method can only stay in a laboratory stage. Moreover, a manufacturing size thereof is difficult to control. Therefore, the present invention provides a method for preparing a chitosan nanofiber by mechanical means, which can prepare the chitosan nanofiber on a large scale based on principles of papermaking and beating, reduce a preparation cost of the chitosan nanofiber, and simultaneously prepares a fibrous fibrillated chitosan nanofiber.

### SUMMARY

Aiming at the shortcomings and defects of a current method for preparing a chitosan nano material, an objective of the present invention is to provide a method for preparing chitosan and a derivative nanofiber thereof by mechanical means. The method uses a chitosan fiber or a chitosan derivative fiber as a main raw material, uses a basic process of beating production of a papermaking fiber, has the advantages of a simple process, continuous production, use of a fibrous chitosan raw material as a basic production raw material, a low cost, etc., and overcomes the shortcomings of existing products such as a complex operation, a single form of nano chitosan, and an ultra-low temperature environment for preparation. Meanwhile, a process technology and a device are very mature in a papermaking and beating production process, requirements on the raw material are relatively low, and most participating media may be reused, thus being beneficial for reducing a cost, realizing industrial production, and effectively promoting wide application of a chitosan nanofiber.

A principle of the present invention is that the chitosan fiber or the chitosan derivative fiber is used as the basic raw material, which is pre-treated by swelling, an alkaline solution or an acid solution first, then the treated fiber raw material is refined (beated), and the treated raw material is nano-homogenized by a homogenizer to obtain the chitosan nanofiber. The method is simple in operation and may realize continuous production, the obtained fibrous nano chitosan is nano chitosan with a new topology, and the chitosan nanofiber prepared by the method has great industrial and medical application values and social benefits.

The objective of the present invention is achieved by the following technical solutions.

A method for preparing chitosan and a derivative nanofiber thereof by mechanical means comprises the following steps:

(1) cutting a chitosan fiber or a chitosan derivative fiber material into a proper length (less than 30 mm), and then pre-treating the fiber material with clear water (deionized water is used under a higher requirement), dilute acid or dilute alkali to swell the fiber, thus being beneficial for subsequent treatment;

(2) refining or beating the treated fiber material in the step (1), and cutting, fibrillating, and finely fiberizing the fiber as needed to obtain fiber pulp;

(3) putting the fiber pulp obtained in the step (2) into deionized water, and fully defibering and diluting the fiber pulp into a turbid liquid by a fluffer; and

(4) homogenizing the chitosan fiber suspension turbid liquid prepared in the step (3) in a high-pressure homogenizer, and repeating the homogenizing for many times to prepare a chitosan nanofiber emulsion.

Preferably, the fiber material used in the step (1) is characterized in that: a main raw material is a fibrous raw material, and a main component is chitosan, and a fiber topology thereof is similar to a fiber raw material component which may be used in a papermaking process.

Further preferably, the fiber material in the step (1) is the chitosan fiber or chitosan derivative fiber material with a length of 1 mm to 3 mm and a width of 5 μm to 30 μm; and a mass concentration of the dilute acid or the dilute alkali is 0.05 wt % to 10 wt %, for example, a 1 wt % sodium hydroxide solution is used as a pre-treatment solution, and a pulp treatment concentration is 3% (a weight ratio of a solid matter).

Preferably, the refining or beating in the step (2) uses a conventional refining/beating process treatment method in the papermaking process; a device for the refining or beating is a mechanical treatment device for finely fiberizing the fiber material; the mechanical treatment device is a disc refiner, a conical refiner or a cylindrical refiner in the papermaking process; and the mechanical treatment device further comprises an intermittent beating device: a trough beater.

Preferably, the fluffer in the step (3) is a LW pulp fluffer, a high-efficiency fluffer and other fluffer devices; and a concentration of the chitosan fiber is 0.01 wt % to 1 wt %, which is preferably 0.03 wt %.

Preferably, the homogenizer in the step (4) is a high-pressure micro-jet nano disperser MINI (large machine), an ultrahigh-pressure nano homogenizer Nano DeBEE (small machine) and other nano homogenizer devices.

Preferably, the homogenizing in the step (4) is performed for 5 times to 40 times, and is preferably performed for 10 times; and an operating temperature is 10° C. to 60° C., which is preferably 20° C., and when the temperature rises too high during operation, the machine needs to be stopped for cooling.

Preferably, when a size of the fiber material after cutting is less than 1 mm, the dispersed and diluted fiber pulp is directly subjected to the treatment of the step (3) without going through the treatment of the step (1) and the treatment of the step (2).

Compared with the prior art, the present invention has the following advantages and effects.

1. Compared with chitosan nanoparticles and chitosan nanofibers obtained by a freezing method, the present invention can prepare the fibrous fibrillated chitosan nanofiber topology, and a size of the chitosan nanofiber can be controlled by adjusting a beating condition and homogenizing times.

2. Compared with the chitosan nanoparticles and the chitosan nanofibers obtained by the freezing method, the present invention prepares the fibrillated chitosan nanofiber, and a branched chain contained in single fiber makes connection between the fibers closer, and increase of binding sites is beneficial for composition of the chitosan nanofiber with other materials and modification.

3. Compared with the chitosan nanoparticles and the chitosan nanofibers obtained by the freezing method, the preparation process of the present invention is simple, and the chitosan nanofiber is mainly prepared by the mechanical means without introducing other groups, thus being beneficial for purification of the chitosan nanofiber, improving a biocompatibility thereof, and being beneficial for applying the chitosan nanofiber in medicine.

4. Compared with the chitosan nanoparticles and the chitosan nanofibers obtained by the freezing method, the present invention uses the mature process method and device in a papermaking industry, thus reducing a production cost, being expected to perform large-scale industrial production, and providing an efficient preparation basis for wide application of the chitosan nanofiber.

### BRIEF DESCRIPTION OF THE DRAWINGS

FIG. 1 is a TEM image of a chitosan nanofiber prepared in Embodiment 1.

FIG. 2 is a TEM image of a chitosan nanofiber prepared in Embodiment 3.

FIG. 3 is a TEM image of a chitosan nanofiber prepared in Embodiment 5.

### DESCRIPTION OF THE EMBODIMENTS

The present invention is further described in detail hereinafter with reference to the embodiments and the accompanying drawings, but the embodiments of the present invention are not limited to this. It should be noted that the following processes, if not specifically described in detail, can be realized or understood by those skilled in the art with reference to the prior art.

### Embodiment 1

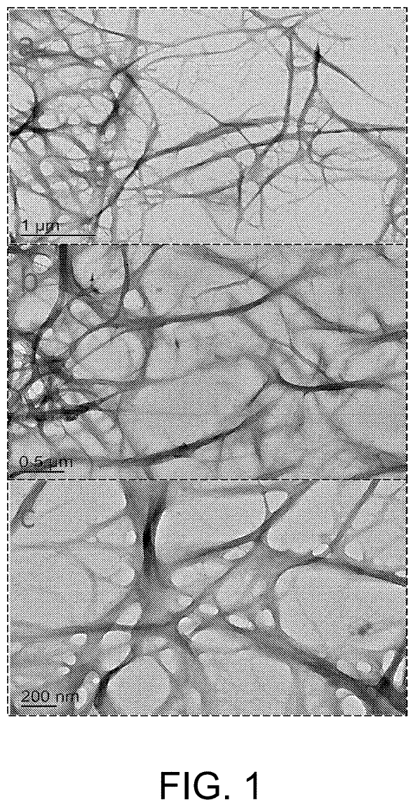

30 g of chitosan fibers were cut into a length of 1 mm to 3 mm first, and put into deionized water to fully absorb water and swell for 8 hours, and then pulp was poured into a filter screen and kneaded to remove water. The dewatered pulp was stood to balance a moisture for 2 hours, and a water content of the pulp after moisture balancing was measured. A dryness of the pulp was adjusted to be 10 wt %, and beating treatment was performed on the pulp with a PFI refiner for 50,000 revolutions. The beated pulp fibers were put into deionized water to disperse into a pulp suspension with a concentration of 0.3 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 5 times. FIG. 1 is a TEM image of the chitosan nanofiber in Embodiment 1 (wherein a, b and c correspond to different magnification scales). It can be seen from FIG. 1 that a diameter of the chitosan nanofiber reaches a nano-level in a projection electron microscope image of the treated chitosan fiber.

### Embodiment 2

30 g of chitosan derivative fibers were cut into a length of 30 mm first, and put into a 10 wt % alkaline solution to soak for 1 hour, and then pulp was poured into a filter screen and washed with water for many times until a washing liquor was alkalescent. Water was removed through squeezing, the dewatered pulp was stood to balance a moisture for 2 hours, and a water content of the pulp after moisture balancing was measured. A dryness of the pulp was adjusted to be 10 wt %, and beating treatment was performed on the pulp with a PFI refiner for 80,000 revolutions. The beated pulp fibers were put into deionized water to disperse into a pulp suspension with a concentration of 0.01 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 40 times. A diameter of the chitosan nanofiber also reached a nano-level.

### Embodiment 3

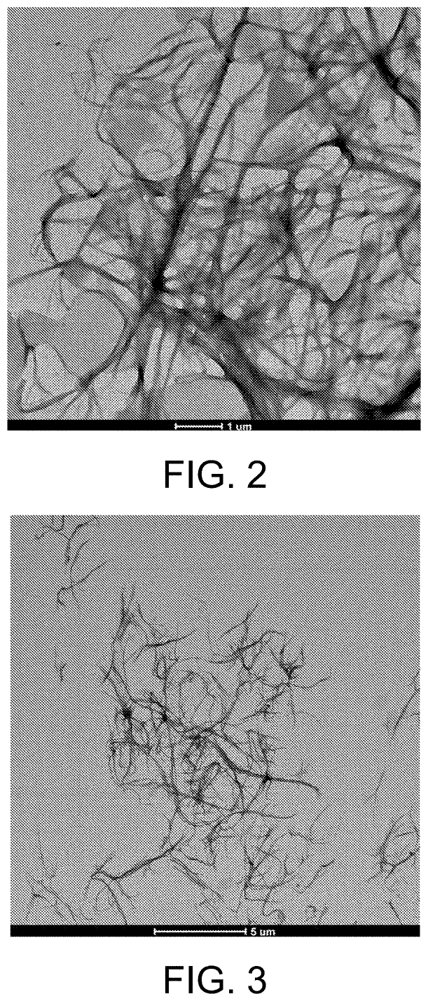

30 g of chitosan fibers were cut into a length of 3 mm to 5 mm first, and put into a 0.05 wt % acid solution to soak for 0.5 hour, and then pulp was poured into a filter screen and washed with water for many times until a washing liquor was weakly acidic. Water was removed through squeezing, the dewatered pulp was stood to balance a moisture for 2 hours, and a water content of the pulp after moisture balancing was measured. A dryness of the pulp was adjusted to be 10 wt %, and beating treatment was performed on the pulp with a cylindrical refiner for 50,000 revolutions. The beated pulp fibers were put into deionized water to disperse into a pulp suspension with a concentration of 1 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 20 times. As shown in FIG. 2, a diameter of the chitosan nanofiber also reached a nano-level.

### Embodiment 4

30 g of chitosan fibers were cut into a length of 10 mm to 15 mm first, and put into a 0.1 wt % acid solution to soak for 0.5 hour, and then pulp was poured into a filter screen and washed with water for many times until a washing liquor was weakly acidic. Water was removed through squeezing, the dewatered pulp was stood to balance a moisture for 2 hours, and a water content of the pulp after moisture balancing was measured. A dryness of the pulp was adjusted to be 10 wt %, and beating treatment was performed on the pulp with a cylindrical refiner for 80,000 revolutions. The beated pulp fibers were put into deionized water to disperse into a pulp suspension with a concentration of 0.5 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 25 times. A diameter of the chitosan nanofiber also reached a nano-level.

### Embodiment 5

30 g of chitosan fibers were cut into a length of 15 mm to 20 mm first, and put into 5 wt % alkaline solution to soak for 2 hours, and then pulp was poured into a filter screen and washed with water for many times until a washing liquor was alkalescent. Water was removed through squeezing, the dewatered pulp was stood to balance a moisture for 2 hours, and a water content of the pulp after moisture balancing was measured. A dryness of the pulp was adjusted to be 10 wt %, and beating treatment was performed on the pulp with a conical refiner for 100,000 revolutions. The beated pulp fibers were put into deionized water to disperse into a pulp suspension with a concentration of 0.1 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 20 times. As shown in FIG. 3, a diameter of the chitosan nanofiber also reached a nano-level.

### Embodiment 6

30 g of chitosan fibers were cut into a length of 3 mm to 5 mm first, and put into deionized water to fully absorb water and swell for 8 hours, and then pulp was poured into a filter screen and kneaded to remove water. The dewatered pulp was stood to balance a moisture for 2 hours, and a water content of the pulp after moisture balancing was measured. A dryness of the pulp was adjusted to be 10 wt %, and beating treatment was performed on the pulp with a conical refiner for 100,000 revolutions. The beated pulp fibers were put into deionized water to disperse into a pulp suspension with a concentration of 0.03 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 10 times. A diameter of the chitosan nanofiber also reached a nano-level.

### Embodiment 7

1 g of chitosan fibers with a length less than 1 mm were put into deionized water to disperse into a pulp suspension with a concentration of 0.03 wt %. The suspension was put into a fluffer for defibering, so that the fibers were evenly dispersed in water. The evenly dispersed fiber turbid liquid was poured into a homogenizer for homogenizing, and a chitosan nanofiber emulsion could be obtained after homogenizing for 30 times. A diameter of the chitosan nanofiber also reached a nano-level.

What is claimed is:

1. A method for preparing chitosan and a derivative nanofiber thereof by mechanical means, characterized in that, the method comprises the following steps:
(1) cutting a fiber material, and then soaking the fiber material in deionized water or pre-treating the fiber material with dilute alkali or dilute acid, wherein the fiber material is a chitosan fiber or a chitosan derivative fiber;
(2) performing preliminary mechanical treatment on the pre-treated fiber material in the step (1) by a refining or beating device to obtain a micro-sized fiber pulp;
(3) putting the micro-sized fiber pulp obtained in the step (2) into deionized water, and defibering and diluting the micro-sized fiber pulp into a fiber turbid liquid by a fluffer; and
(4) homogenizing the fiber turbid liquid prepared in the step (3) in a high-pressure homogenizer to prepare a chitosan nanofiber emulsion.

2. The method according to claim 1, characterized in that, a fiber length of the fiber material after cutting in the step (1) is less than 30 mm; and a mass concentration of the dilute acid or the dilute alkali is 0.05 wt % to 10 wt %.

3. The method according to claim 1, characterized in that, the refining or beating device in the step (2) is a mechanical treatment device for finely fiberizing the fiber material.

4. The method according to claim 3, characterized in that, the mechanical treatment device is a continuous beating device in a papermaking process, which is a disc refiner, a conical refiner or a cylindrical refiner.

5. The method according to claim 3, characterized in that, the mechanical treatment device further comprises an intermittent beating device, which is a trough beater.

6. The method according to claim 1, characterized in that, a mass concentration of the fiber turbid liquid in the step (3) is 0.01 wt % to 1 wt %.

7. The method according to claim 1, characterized in that, the high-pressure homogenizer in the step (4) is a nano homogenizer.

8. The method according to claim 7, characterized in that, the nano homogenizer is a high-pressure micro-jet nano disperser MINI or an ultrahigh-pressure nano homogenizer Nano DeBEE.

9. The method according to claim 1, characterized in that, when a size of the fiber material after cutting is less than 1 mm, the fiber after being dispersed with water is directly subjected to the treatment of the step (3) without going through the treatment of the step (1) and the treatment of the step (2).

10. The method according to claim 1, characterized in that, the homogenizing in the step (4) is performed for 5 times to 40 times; and an operating temperature is 10° C. to 60° C.
